(19) United States
(12) Patent Application Publication
(10) Pub. No.: US 2014/0218484 A1
(43) Pub. Date: Aug. 7, 2014

(54) STEREOSCOPIC IMAGE PICKUP APPARATUS

(71) Applicant: Canon Kabushiki Kaisha, Tokyo (JP)

(72) Inventor: Koji Iwashita, Kawasaki-shi (JP)

(73) Assignee: Canon Kabushiki Kaisha, Tokyo (JP)

(21) Appl. No.: 14/164,816

(22) Filed: Jan. 27, 2014

(30) Foreign Application Priority Data
Feb. 5, 2013 (JP) 2013-020246

(51) Int. Cl. H04N 13/00; H04N 13/02

(52) U.S. Cl. CPC H04N 13/0007; H04N 13/0242
USPC 348/47

(57) ABSTRACT

A stereoscopic image pickup apparatus includes a plurality of image pickup units configured to acquire a plurality of images at each viewpoint by photographing an object from a plurality of different viewpoints, a measuring unit configured to measure an object distance which is a distance between the plurality of image pickup units and the object, a calculation unit configured to calculate an effective range where the plurality of images becomes parallax viewable stereoscopically, a control unit configured to control a focal length of the plurality of the image pickup units so that the object distance and the focal length are within the effective range and an image expanding and reduction unit configured to expand each image region of the plurality of images according to a control of the focal length by the control unit.

### BACKGROUND OF THE INVENTION

1. Field of the Invention

The present invention relates to a stereoscopic image pickup apparatus capable of photographing stereoscopic images.

2. Description of the Related Art

In recent years, digital cameras and video cameras capable of photographing an object stereographically are produced commercially. Images photographed by two lenses are reproduced as stereographic images by using left and right parallax. In an image photographing apparatus not having a convergence angle and an angle adjustment function, an area where stereographic images are photographable is decided by a relation between a distance to the object and a focal length.

FIGS. 11A and 11B are schematic views of parallax in differences of a focal length in the case an object distance is a short distance. FIG. 11A illustrates a state where the focal length is a wide side and FIG. 11B illustrates a state where the focal length is a telephoto side.

Lenses 1102L and 1102R respectively photograph images for left eyes and right eyes of cameras. Both object distances 1104 of FIGS. 11A and 11B are equal. As illustrated in FIG. 11A, when the focal length is the wide side, a stereographic photographing is performable at an object position 1101 since a parallax amount between images 1103R and 1103L is moderate. As illustrated in FIG. 11B, when the focal length is the telephoto side, a stereoscopic effect is damaged at the object position 1101 since there are little overlapping parts of the images 1103R and 1103L and a parallax amount between the left and right becomes too large.

In other words, when users operates to the telephoto side so as to perform zooming, the users cannot view stereoscopically since a parallax amount between the left and right becomes too large.

FIGS. 12A and 12B are schematic diagrams of parallax in differences of an object distance. FIG. 12A illustrates a state where the object distance is a short distance and FIG. 12B illustrates a state where the object distance is a middle distance.

Lenses 1202L and 1202R respectively photograph images for left eyes and right eyes of cameras. As illustrated in FIG. 12A, when an object distance 1204 is a short distance, a stereoscopic effect is damaged at an object position 1201 since there are little overlapping parts of images 1203R and 1203L and a parallax amount between the left and right becomes too large. As illustrated in FIG. 12B, when the focal length 1204 is a middle distance, a stereographic photographing is performable at the object position 1201 since a parallax amount between the images 1203R and 1203L is moderate.

In other words, when the object distance is too close, the users cannot view stereoscopically since a parallax amount between the left and right becomes too large.

Japanese Patent Laid-Open No. 2008-205758 discloses a system where a distance from a camera to an object is measured and a zoom magnification is adjusted when the object is positioned at a close distance.

However, in Japanese Patent Laid-Open No. 2008-205758, the object becomes smaller and is hard to watch since a focal length is changed to a wide side and an angle of view is changed when the distance between the camera and the object becomes shorter.

### SUMMARY OF THE INVENTION

In view of these problems, it is an object of the present invention to provide a stereoscopic image pickup apparatus capable of properly setting a size of an object while maintaining an appropriate parallax amount.

A stereoscopic image pickup apparatus as an aspect of the present invention includes a plurality of image pickup units configured to acquire a plurality of images at each viewpoint by photographing an object from a plurality of different viewpoints, a measuring unit configured to measure an object distance which is a distance between the plurality of image pickup units and the object, a calculation unit configured to calculate an effective range where the plurality of images becomes parallax viewable stereoscopically, a control unit configured to control a focal length of the plurality of the image pickup units so that the object distance and the focal length are within the effective range and an image expanding and reduction unit configured to expand each image region of the plurality of images according to a control of the focal length by the control unit

Further features of the present invention will become apparent from the following description of exemplary embodiments (with reference to the attached drawings).

### BRIEF DESCRIPTION OF THE DRAWINGS

FIG. 1 is a block diagram illustrating a configuration of a stereoscopic image pickup apparatus according to an embodiment of the present invention.

FIG. 2 is a block diagram illustrating a configuration changing a focal length.

FIG. 3 is a flowchart explaining operations when the focal length changes.

FIGS. 4A to 4C are schematic diagrams illustrating operations of a segmentation region calculation unit.

FIGS. 5A and 5B are schematic diagrams illustrating a relation of the focal length and parallax.

FIG. 6 is a processing flow illustrating a configuration constantly maintaining an angle of view.

FIG. 7 is a flowchart explaining operations when an object approaches.

FIG. 8 is a schematic diagram illustrating a relation of the focal length and the object distance.

FIGS. 9A to FIG. 9H are schematic diagrams illustrating operations of the segmentation region calculation unit.

FIG. 10 is a schematic diagram illustrating a relation of the object distance and parallax.

FIGS. 11A and 11B are schematic views of parallax in differences of the focal length in the case the object distance is a short distance

FIGS. 12A and 12B are schematic diagrams of parallax in differences of the object distance

### DESCRIPTION OF THE PREFERRED EMBODIMENTS

Exemplary embodiments of the present invention will be described below with reference to the accompanied drawings.

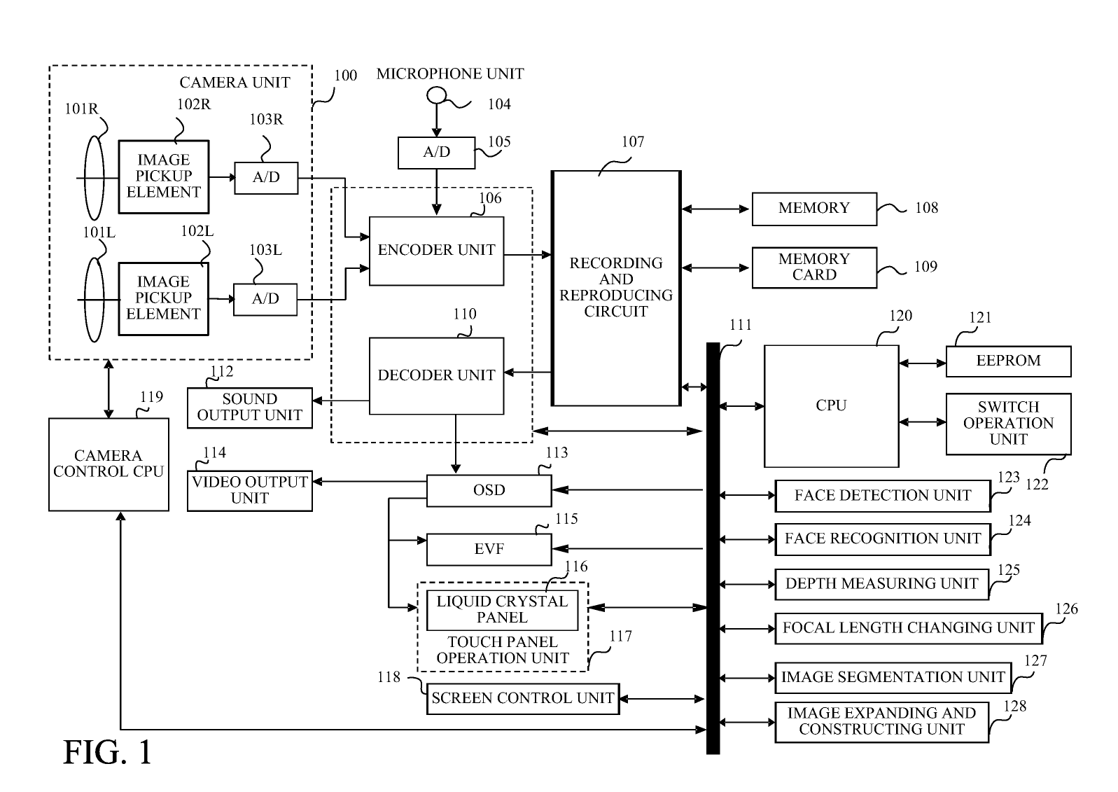

FIG. 1 is a block diagram of a stereoscopic image pickup apparatus according to an embodiment of the present invention.

A camera unit 100 has two image pickup units which comprise a lens unit, an image pickup element and an A/D processing unit so as to create a stereoscopic image by photographing from left and right viewpoints. Additionally, though it is not illustrated in FIG. 1, the camera unit 100 also includes variable power lens groups, actuators such as an aperture, sensors for image stabilization (e.g., an angular velocity sensor) and means for image stabilization (e.g., a shift lens).

Lens units 101R and 101L include a fix lens group for collecting a light, a variable power lens group, an aperture and a correction lens group which corrects an imaging position moving according to movement of the variable power lens group and performs focusing. The lens units 101R and 101L respectively form optical images of an object on imaging surfaces of image pickup elements 102R and 102L. The image pickup elements 102R and 102L are photoelectric conversion elements constituted by a CCD sensor or a CMOS sensor, and output image pickup signals by photoelectrically converting the object formed on the imaging surfaces. The A/D processing units 103R and 103L perform a predetermined processing to the image pickup signals output from the image pickup elements 102R and 102L, and output digital image data.

A microphone unit 104 is used for collecting sound in the case of photographing, and performs a predetermined amplification and a band limiting. An A/D processing unit 105 outputs a digital sound data in response to the output of the microphone unit 104.

An encoder unit 106 receives the digital image date from the A/D processing units 103R and 103L and the digital sound data from the A/D processing unit 105 so as to compress a video by a control of a CPU (a Central Processing Unit) 120. The digital image data has parallax for a right and left eye input from the two image pickup units. Data compressed a video is further multiplexed in chronological order so as to generate a compression video data. Additionally, the encoder unit 106 notices information, for example, necessary for conversion of a data position and a frame position to the CPU 120.

A recording and reproducing circuit 107 has an interface with the encoder unit 106, a memory 108, a memory card 109, a decoder unit 110, and a bus 111. The recording and reproducing circuit 107 controls transfer of data by the control of the CPU 120 connected to the bus 111. The recording and reproducing circuit 107 has a direct memory access (DMA) function that reading data and writing data are automatically transferred by specifying the leading address and the data amounts of the memory 108 and the write leading address of the memory card 109.

Video data photographed is stored in the memory card 109. The memory card 109 is not only a recording medium and has an interface connectable to the recording and reproducing circuit 107 so as to read/write data to the memory card 109.

The decoder unit 110 sequentially reads a compression video data and a compression still image data from the address of the memory 108 specified by the CPU 120.

The read compression video data and compression still image data is converted to a digital video signal and a digital sound signal, e.g., ITU-R BT.656 (CCIR656) so as to output. A reduction processing is performable, if necessary, in the case of reproducing the compression still image data.

The buss 111 is connected to each block and is a transmission path which transfers a data according to the control of the CPU 120.

A sound output unit 112 converts the digital sound data converted by the decoder unit 110 to a predetermined signal so as to output the signal to the outside and is connected to a television receiver.

An on screen display (hereinafter referred to as “an OSD”) 113 overlaps a video output with information such as a menu screen so as to perform various settings, a title and a time. Additionally, the OSD 113 captures a digital video signal input from the decoder unit 110, processes a reduction processing to the signal and overlaps the signal at an arbitrary position. A video output unit 114 converts the digital sound data converted by the decoder unit 110 to a predetermined signal so as to output the signal to the outside and is connected to a television receiver.

An EVF (Electronic View Finder) 115 is used as a small window so as to look into the object. A liquid crystal panel 116 is used as a monitor screen so as to display the object. A touch panel operation unit 117 is used along with the liquid crystal panel 116. Thumbnail images and virtual buttons are displayed by the liquid crystal panel 116 and accept the operation of the users by the touch panel operation unit 117. A screen control unit 118 calculates input from the touch panel operation unit 117 and decides pushing of the virtual buttons. Further, the screen control unit 118 also performs a control of the virtual buttons so as to output to the liquid crystal panel 116.

A camera control CPU 119 controls the camera unit 100 according to the control of the CPU 120. Additionally, the camera control CPU 119 transmits information of the camera unit 100, e.g., focus information and image stabilization information acquired from the camera unit 100, to the CPU 120.

The CPU 120 controls the whole system. The CPU 120 has a non-volatile memory (a ROM) storing programs, a volatile memory (a RAM) which becomes an operation region, an external bus so as to transfer data to other hardware and access to a control register, and a timer measuring time. The CPU 120 includes software handling a predetermined file system. According to this file system, reading and writing of data to the memory card 109 are performed. An EEPROM 121 is rewritable ROM. A switch operation unit 122 includes a switch which starts a recording of a video and a zoom button which changes the focal length. The CPU 120 decides input signals by operations of the users so as to operate the switch operation unit 122.

A face detection unit 123 performs a face detection processing to the image data photographed by the image pickup elements 102R and 102L so as to detect face area of figures included in the image. The face detection processing is performed by the well-known algorithm. For example, feature points such as each end point of eyes, noses and mouths and a contour point of faces are extracted from data of a through image or an image by the well-known processing which extracts feature points, and the face area of the objects and the size of the faces are detected based on these feature points.

A face recognition unit 124 generates face authentication data which indicates the feature of the face as the authentication object based on the output of the face detection unit 123. For example, the face recognition unit 124 generates the face authentication data from the position of the feature points of the detected face, the size of the face part acquired from the feature points, and a relative distance of each feature point.

A depth measuring unit 125 performs a depth detection processing by the well known detection method and measures distance information between the camera and the object.

A focal length changing unit 126 changes the focal length according to the zooming from the user.

An image segmentation unit 127 segments a part of the image region from the image and an image expanding and reduction unit 128 performs expanding and constructing of image so as to realize a digital zoom.

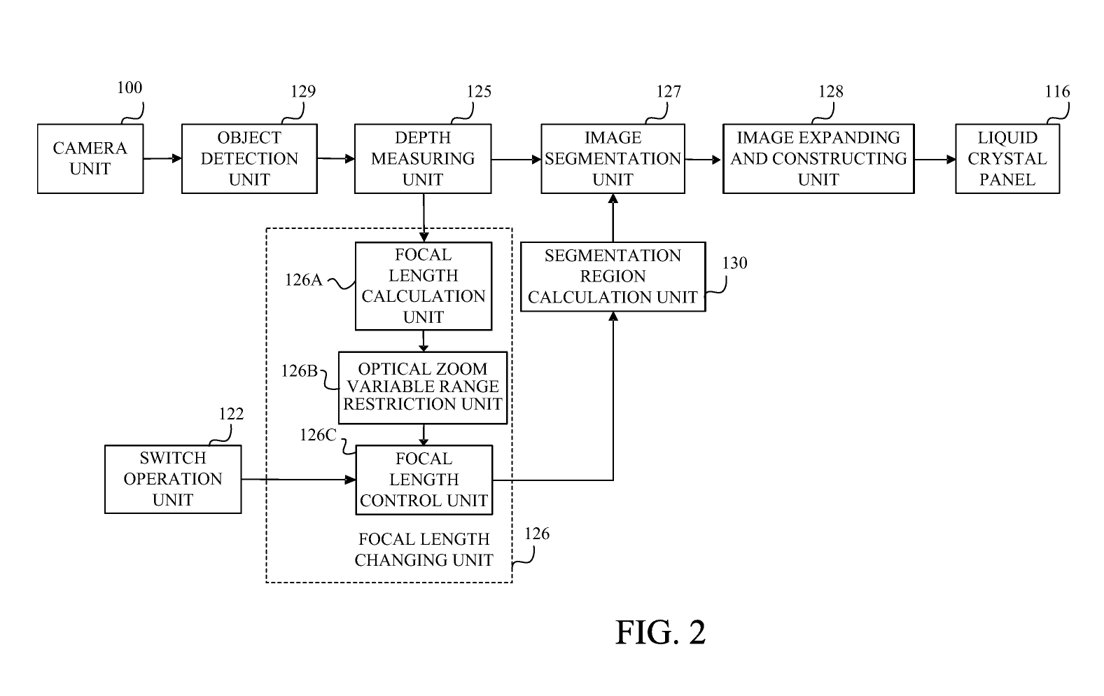

FIG. 2 is a block diagram illustrating a configuration changing a focal length.

An object detection unit 129 includes the face detection unit 123 and the face recognition unit 124, and detects the object of the image input from the camera unit 100.

The focal length changing unit 126 has a focal length calculation unit 126A, an optical zoom variable range restriction unit 126B, and a focal length control unit 126C.

The focal length calculation unit 126A calculates an optical zoom effective range viewable stereoscopically according to a distance between the camera detected by the depth measuring unit 125 and the object. Calculation of the focal length viewable stereoscopically is determined with reference to the focal length variable range table in the EEPROM 121. In this embodiment, since the convergence angle and the base length of the lens units 101R and 101L are always fixed, the focal length variable range table is previously prepared.

The optical zoom variable range restriction unit 126B sets the optical zoom effective range calculated by the focal length calculation unit 126A to the focal length control unit 126C. The switch operation unit 122 notifies focal length change instruction to the focal length changing unit 126C according to the zooming of the user.

The focal length control unit 126C changes the focal length of the lens unit according to instructed focal length. When the user sets the focal length control unit 126C to a focal length outside the optical zoom effective range, the focal length control unit 126C restricts a focal length to the restriction value of the optical zoom variable range restriction unit 126B.

A segmentation region calculation unit 130 calculates a segmentation position of the image according to the output from the focal length control unit 126C. The segmentation region calculation unit 130, as described later, calculates the segmentation position viewable stereoscopically.

The image segmentation unit 127 segments a part of image region from an image based on the segmentation region calculation unit 130. The segmented image is expanded and constructed by the image expanding and constructing unit 128 and is displayed on the liquid crystal panel 116.

When the focal length input from the switch operation unit 122 is within the optical zoom effective range, the image segmentation unit 127 outputs original images to the liquid crystal panel 116 without segmenting the image.

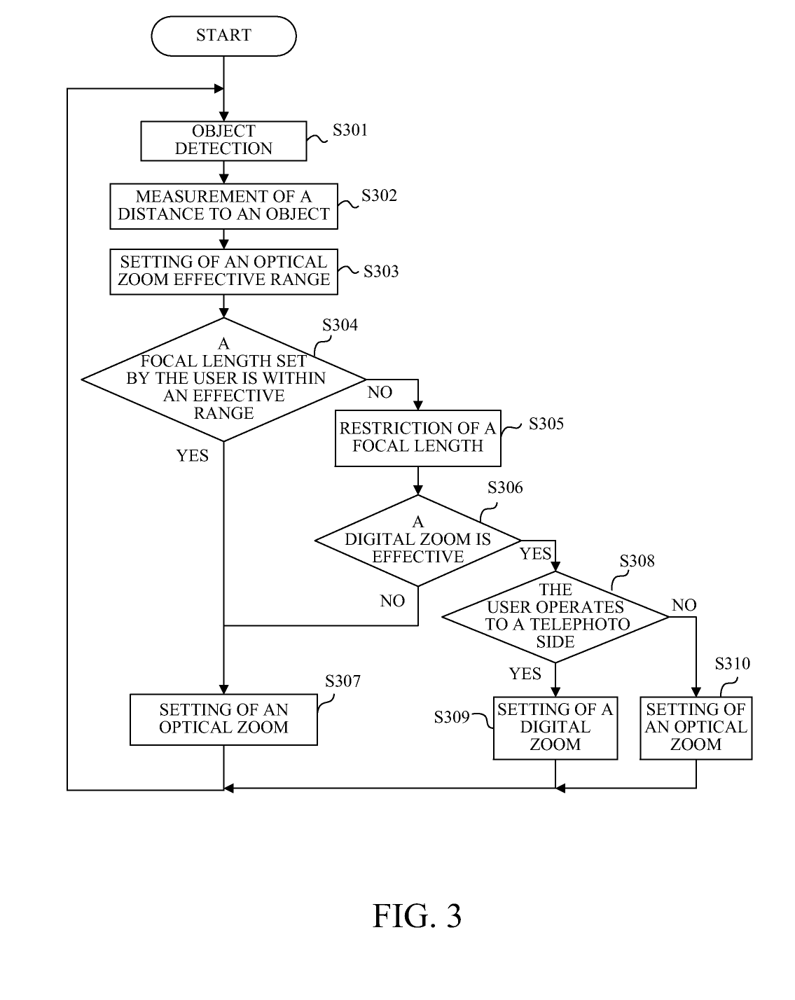

The operation at the change of the focal length is explained by using the flowchart of FIG. 3.

In S301, the face detection unit 123 detects the object from the input image and the face recognition unit 124 recognizes the object.

In S302, the depth measuring unit 125 measures a distance between the camera and the object.

In S303, the optical zoom variable range restriction unit 126B sets the optical zoom effective range calculated by the focal length calculation unit 126A to the focal length control unit 126C.

In S304, the focal length operated by the user is compared with the optical zoom effective range set in S303. When the focal length operated by the user is within the optical zoom effective range, the optical zoom is set in S307. The optical zoom sets the focal length input from the switch operation part 122 to the focal length control unit 126C and changes the focal length of the lens units 101R and 101L. When the focal length operated by the user exceeds the optical zoom effective range, the focal length input from the switch operation unit 122 is restricted to the restriction value of the optical zoom variable range and the restriction value of the optical zoom variable range is set to the focal length control unit 126C in S305. The difference value of the focal length restricted in S305 is set to the segmentation region calculation unit 130. The segmentation region calculation unit 130 calculates the segmentation position corresponding to the difference value of the focal length.

In S306, it is judged whether the digital zoom of the stereoscopic image pickup apparatus of this embodiment is effective or not. When the digital zoom is not effective, the optical zoom is set to the restricted focal length. When the digital zoom is effective, it is judged whether the user operates the focal length of the switch operation part 122 to the telephoto side or not in S308.

In S308, when the user operates the focal length to the telephoto side, it proceeds to S309. In S309, the digital zoom is set and the segmentation position is changed.

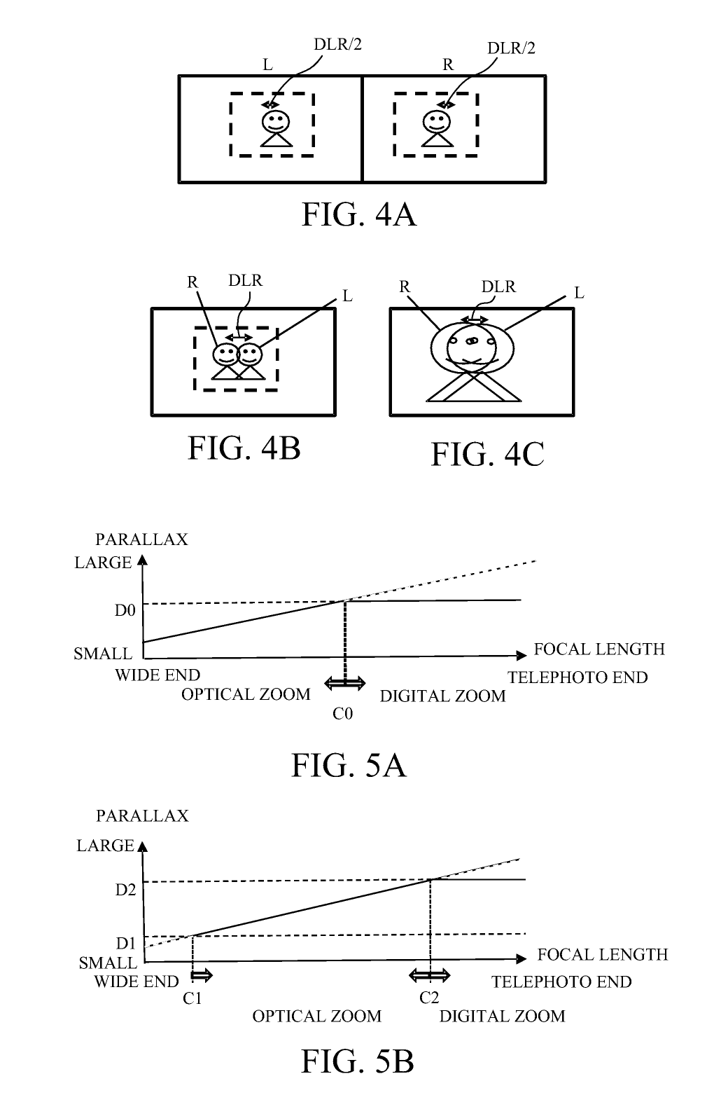

The operation of the segmentation region calculation unit 130 is explained by using FIGS. 4A to 4C. A plurality of images for the left and right eyes input from the lens units 101R and 101L are placed on the memory and parallax amounts from the center of the image is detected.

FIG. 4A illustrates images for the left and right eyes when the optical zoom variable range is restricted to the restriction value on the telephoto end, and each of parallax amounts from the center of the image is DLR/2. FIG. 4B illustrates a stereoscopic image used the images for the left and right eyes in FIG. 4A. The object is photographed on the left side in the right image R and the object is photographed on the right side in the left image L. The right image R and the left image L horizontally move to DLR/2 from the center of the image, and binocular parallax is DLR. The dotted line of the frame in FIGS. 4A and 4B indicates segmentation regions and are decided by setting focal length.

FIG. 4C illustrates a stereoscopic image used the images for the left and right images in FIG. 4A performing digital zoom. Binocular parallax between the image R for the right eyes and the image L for the left eyes is DLR. For example, when the focal length input from the switch operation unit 122 is 100 mm and the optical zoom variable range restriction unit 126B restricts the focal length to 40 mm, the focal length control unit 126C sets the optical zoom to 40 mm. The segmentation region calculation unit 130 is set to the digital zoom magnification of 2.5 times (100/40) and is set to a region of 1/2.5.

Here, if the digital zoom magnification is set to “m” times, data multiplied an area, which is multiplied by “1/m” times longitudinally and horizontally from the image R for the right eyes in FIG. 4A and is segmented from the center of the image, by “m” times is stored in the memory. Data multiplied an area, which is multiplied by “1/m” times longitudinally and horizontally from the image L for the left eyes and is segmented from the center of the image, by “m” times is stored in the memory. Data multiplied the image for the right eyes by “m” times is shifted the segmentation position to DLR/2 on the left side, and after is output as an image for the right eyes of FIG. 4C. Additionally, data multiplied the image for the left eyes by “m” times is shifted the segmentation position to DLR/2 on the right side, and after is output as an image for the left eyes of FIG. 4C. In the segmentation area from the image for the left and right eyes of FIG. 4A, the segmentation position may be set, considering shifting the segmentation position to DLR/2 after multiplying by “m” times.

When the image segmentation unit 127 segments the calculated segmentation region and the image expanding and constructing unit 128 expands it, digital zoom is realized.

When the user does not operate the focal length to the telephoto side in S308, it proceeds to S310. In S310, the optical zoom is performed from the restriction value on the wide side restricted by the optical zoom variable range restriction unit 126B and it returns to S301.

FIGS. 5A and 5B are schematic diagrams illustrating a relation of the focal length and parallax.

FIG. 5A illustrates a diagram illustrating a relation of the focal length and parallax when the object distance is a short distance. The horizontal axis and the longitudinal axis indicate the focal length and parallax, respectively. Focal length C0 is a limit value of the focal length on the telephoto side which is viewable stereoscopically. If parallax becomes larger than D0, a stereoscopic effect is damaged since parallax amounts of the left and right becomes too large. When the focal length is operated to the wide side than C0, parallax amounts are amounts capable of viewing stereoscopically. The optical zoom effective range where the focal length is between the wide end and C0 restricts the optical zoom variable range. In the optical zoom effective range, the optical zoom is performed according to the operation of the user. At the time of the optical zoom, the image segmentation unit 127 outputs all images to the liquid crystal panel 116. When the focal length is operated to the telephoto side than C0 and the setting of the digital zoom is invalid, the optical zoom is restricted so that the focal length is C0. When the setting of the digital zoom is valid, the optical zoom is restricted so that the focal length is C0, and further the digital zoom is performed. At the time of the digital zoom, an image region of a part of the images is segmented. The segmentation region calculation unit 130 calculates a region where parallax of the left and right is maintained and the image segmentation unit 127 segments the image. The segmented image is enlarged by the image enlarging and constricting unit 128 so as to output to the liquid crystal panel 116 and record as the image viewable stereoscopically. Digital zoom prevents parallax of the left and right from growing larger, and as a result, a stereoscopic image is photographable.

FIG. 5B illustrates a diagram illustrating a relation of the focal length and parallax when the object distance is a middle distance. Focal length C2 is a limit value of the focal length on the telephoto side which is viewable stereoscopically. If parallax becomes larger than D2, a stereoscopic effect is damaged since parallax amounts of the left and right becomes too large. Focal length C1 is a limit value of the focal length on the wide side which is viewable stereoscopically. If parallax becomes smaller than D1, a stereoscopic effect is damaged since parallax amounts of the left and right becomes too small. When the focal length is between the wide side C1 and the telephoto side C2, parallax amounts are amounts capable of viewing stereoscopically. The optical zoom effective range where the focal length is between C1 and C2 restricts the optical zoom variable range. In the optical zoom effective range, the optical zoom is performed according to the operation of the user. When the focal length is operated to the telephoto side than C1, the optical zoom is restricted so that the focal length is C1. When a focal length is operated to the telephoto side than C2 and the setting of the digital zoom is invalid, the optical zoom is restricted so that the focal length is C2. When the setting of the digital zoom is valid, the optical zoom is restricted so that the focal length is C2, and further the digital zoom is performed. As well as FIG. 5A, digital zoom prevents parallax of the left and right from growing larger, and as a result, a stereoscopic image is photographable.

Therefore, when the zooming is operated in the stereoscopic image pickup apparatus which does not have an angular adjustment function, a stereoscopic image is performable without damaging the stereoscopic effect by restricting a range where the focal length is variable according to a distance to the object.

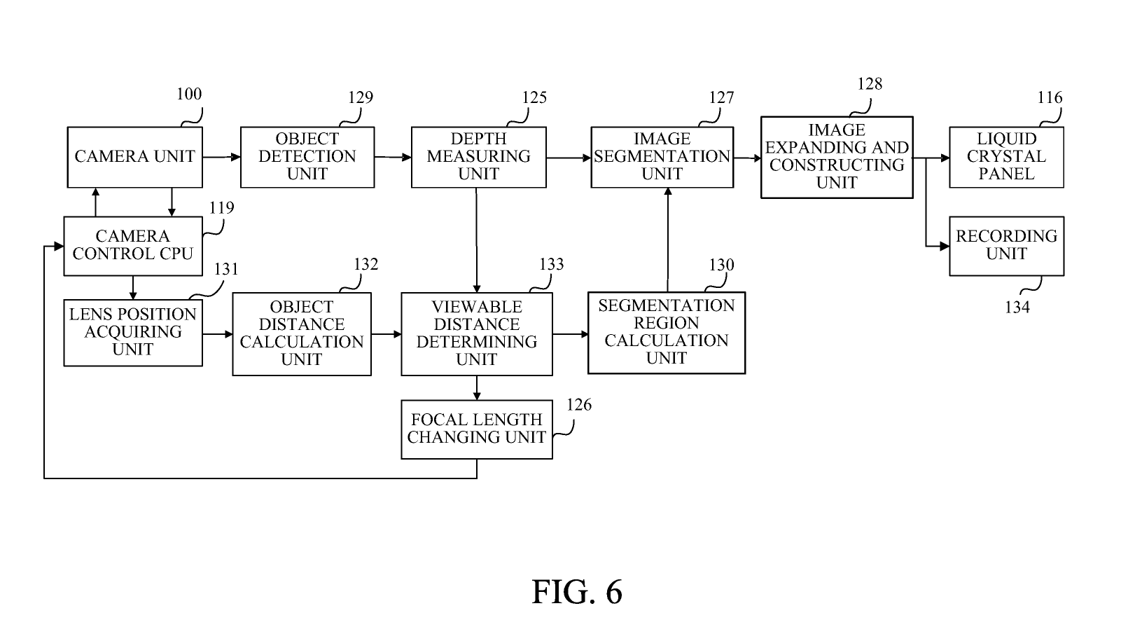

FIG. 6 is a processing flow illustrating a configuration constantly maintaining an angle of view.

A lens position acquiring unit 131 acquires the focal length of the present camera unit 100 from the camera control CPU 119.

An object distance calculation unit 132 calculates an object distance effective range viewable stereoscopically relative to setting focal length. Calculation of the focal length viewable stereoscopically is determined with reference to the object distance effective range table in the EEPROM 121. In this embodiment, since the convergence angle and the base length of the lens units 101R and 101L are always fixed, the relation of the focal length and the object distance is previously prepared as the object distance effective range table.

A viewable distance determining unit 133 determines whether the object is within a distance viewable stereoscopically or not by comparing the distance to the object measured by the depth measuring unit 125 with the object distance effective range of the object distance calculation unit 132.

The focal length changing unit 126 sets the camera control CPU 119 to the focal length according to the focal length set by the viewable distance determining unit 133. The camera control CPU 119 changes the focal length of the camera unit 100.

The segmentation region calculation unit 130 calculates a segmentation position of an image according to a magnification of the viewable distance determining unit 133.

A recording unit 134 includes the recording and reproducing circuit 107 and the memory card 109, and records the image viewable stereoscopically from the image expanding and constructing unit 128.

When the object is within a distance viewable stereoscopically, the image segmentation unit 127 outputs original images to the liquid crystal panel 116 without segmenting the image.

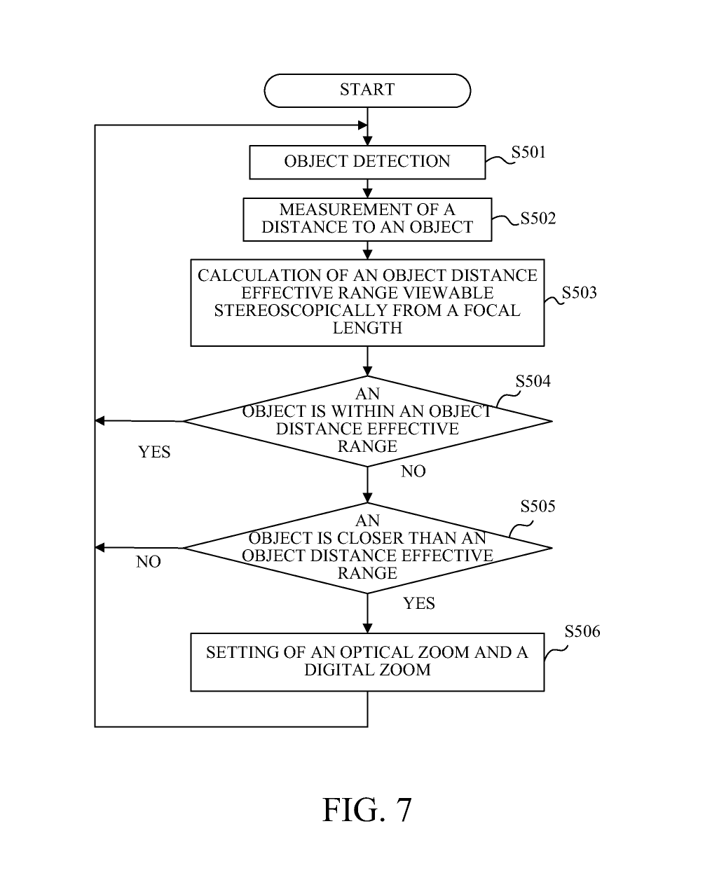

The operation when the object is close is explained by using the flowchart of FIG. 7.

In S501, the face detection unit 123 detects the object from the input image and the face recognition unit 124 recognizes the object.

In S502, the depth measuring unit 125 measures a distance between the camera and the object.

In S503, the object distance calculation unit 132 calculates the object distance effective range viewable stereoscopically from the focal length according to setting focal length.

In S504, the viewable distance determining unit 133 determinates whether the object distance is within the object distance effective range viewable stereoscopically or not. When the object distance is within the object distance effective range, it returns to S501. When the object distance is outside the object distance effective range, it proceeds to S505.

In S505, it is determined whether the object is closer than the object distance effective range or not from the distance to the object. When the object does not approach, it returns to S501. When the object is closer than the object distance effective range, it proceeds to S506.

In S506, the optical zoom and the digital zoom are set so as to maintain the angle of view constantly and keep the stereoscopic effect. The optical zoom is set to the wide side so that the object distance is within the object distance effective range. The focal length is calculated from the object distance and the object distance effective range and is set to the focal length changing unit 126. The digital zoom, as described later, controls parallax amounts by changing the segmentation position from images for the right and left eyes. The segmentation region calculation unit 130 calculates the segmentation position based on the focal length set from the viewable distance determining unit 133.

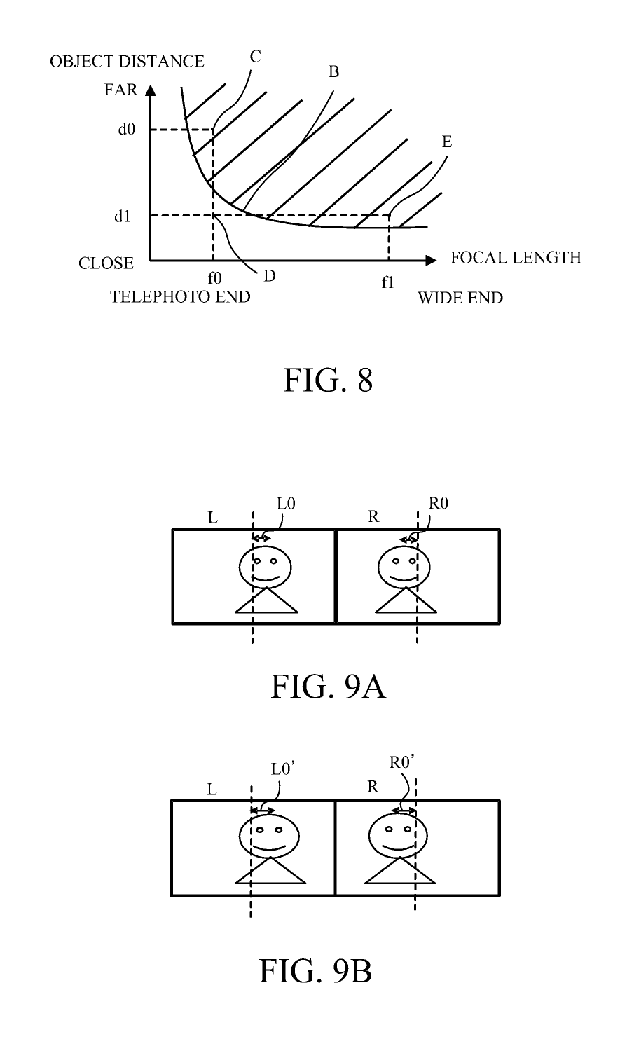

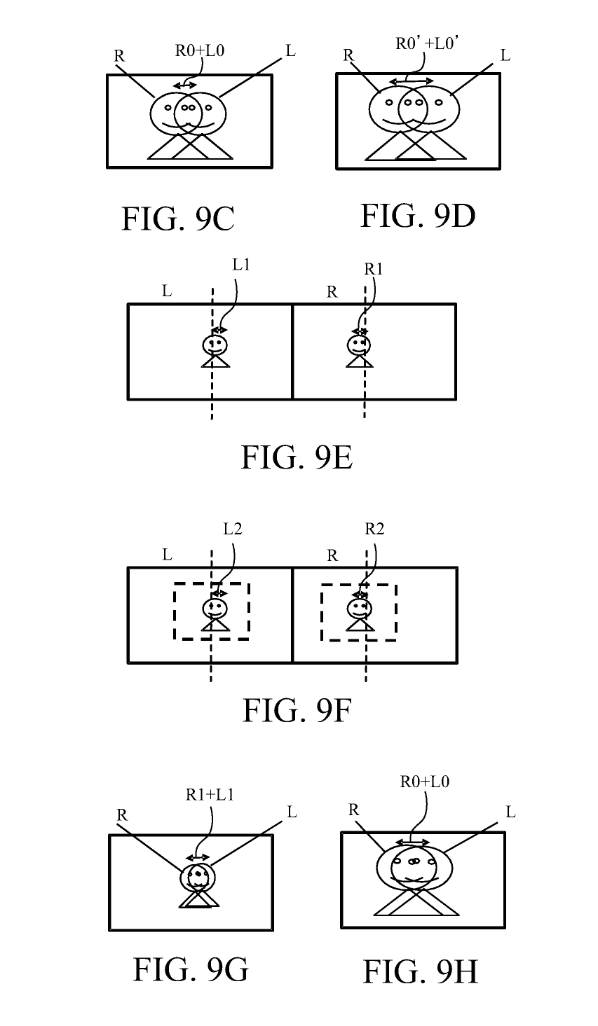

The operation of the segmentation region calculation unit 130 is explained by using FIG. 8 and FIGS. 9A to 9H.

FIG. 8 is a schematic diagram illustrating a relation of the focal length and the object distance. The horizontal axis and the longitudinal axis indicate the focal length and the object distance, respectively. A curve “B” indicates limit values of the object distance viewable stereoscopically relative to the focal length. Stereoscopic viewing is hard when the object distance is closer than the curve B. In the case the focal length is f0, when the object distance is d0, stereoscopic viewing is possible and when the object distance is d1, stereoscopic viewing is hard. In the case the focal length is f1, when the object distance is d1, stereoscopic viewing is possible.

The operation of the segmentation region calculation unit 130 is explained by using FIGS. 9A to FIG. 9H. Images for the left and right eyes input from the lens units 101R and 101L are placed on the memory and parallax amounts from the center of the image as an origin is detected.

FIG. 9A illustrates images for the left and right eyes when the object is positioned at a position viewable stereoscopically (a point “C” in FIG. 8). Parallax amounts from the center of images are L0 and R0, respectively.

FIG. 9C illustrates a stereoscopic image used the images for the left and right images in FIG. 9A. In a right image R, the object is photographed on the left side, and in a left image L, the object L is photographed on the right side. Binocular parallax between the right image R and the left image L is R0+L0.

FIG. 9B illustrates the image when the object approaches and the object distance changes from d0 to d1. FIG. 9B illustrates images for left eyes and right eyes when the object is positioned at a position hard to view stereoscopically (a point “D” in FIG. 8). Parallax amounts from the center of images are L0′ and R0′, respectively.

FIG. 9D illustrates a stereoscopic image used the images for the left and right images in FIG. 9B. In a right image R, the object is photographed on the left side, and in a left image L, the object L is photographed on the right side. Binocular parallax between the right image R and the left image L is R0′+L0′.

In this embodiment, when the object distance changes from d0 to d1 in the case the focal length is f0, the focal distance f1 viewable stereoscopically at the object distance d1 is calculated referring to the object distance effective range table. Calculated focal length f1 is set to the focal length changing unit 126 and the optical zoom is changed from f0 to f1.

An image when setting the optical zoom to the wide side is illustrated in FIG. 9E. FIG. 9E illustrates an image for the left and right eyes when the focal length changes from f0 to f1 in the case the object distance is d1 (a point “E”). Parallax amounts from the center of the images are L1 and R1, respectively. L1 becomes a value that L0′ is multiplied by f1/f0, and R1 becomes a value that R0′ is multiplied by f1/f0.

FIG. 9G illustrates a stereoscopic image used the images for the left and right images in FIG. 9E. In a right image R, the object is photographed on the left side, and in a left image L, the object L is photographed on the right side. Binocular parallax between the right image R and the left image L is R1+L1. Though FIG. 9G is a stereoscopically viewable image, a region based on the output of the segmentation region calculation unit 130 need to segment from FIG. 9E since an angle of view is wide.

FIG. 9H illustrates a stereoscopic image acquired by enlarging a part segmented the dotted line of the frame as illustrated in FIG. 9F from the images for the left and right images in FIG. 9E. The segmentation region calculation unit 130 calculates the segmentation position so that parallax when enlarging becomes R0+L0. The segmentation position for the right eyes R2 horizontally moves a value that (R0′-R0) is multiplied by f1/f0 from the center of the image. The segmentation size is set to a region multiplied by f1/f0. The segmentation position for the left eyes L2 horizontally moves a value that (L0′−L0) is multiplied by f1/f0 from the center of the image. The segmentation size is set to a region multiplied by f1/f0. The segmented image in FIG. 9F is enlarged by the image enlarging and constructing unit 128 so as to stereoscopically view as illustrated in FIG. 9H. Binocular parallax in FIG. 9H is R0+L0 and is equal to binocular parallax in FIG. 9C. The stereoscopic effect is not damaged if the digital zoom is performed so that parallax after the control of the focal length is close to parallax before the control of the focal length.

As stated above, the digital zoom is performed so that the focal length is changed and parallax amounts are constant according to the object distance. The image segmentation unit 127 segments the calculated segmentation region and the image expanding and constructing unit 128 enlarges the segmented region so as to realize the digital zoom.

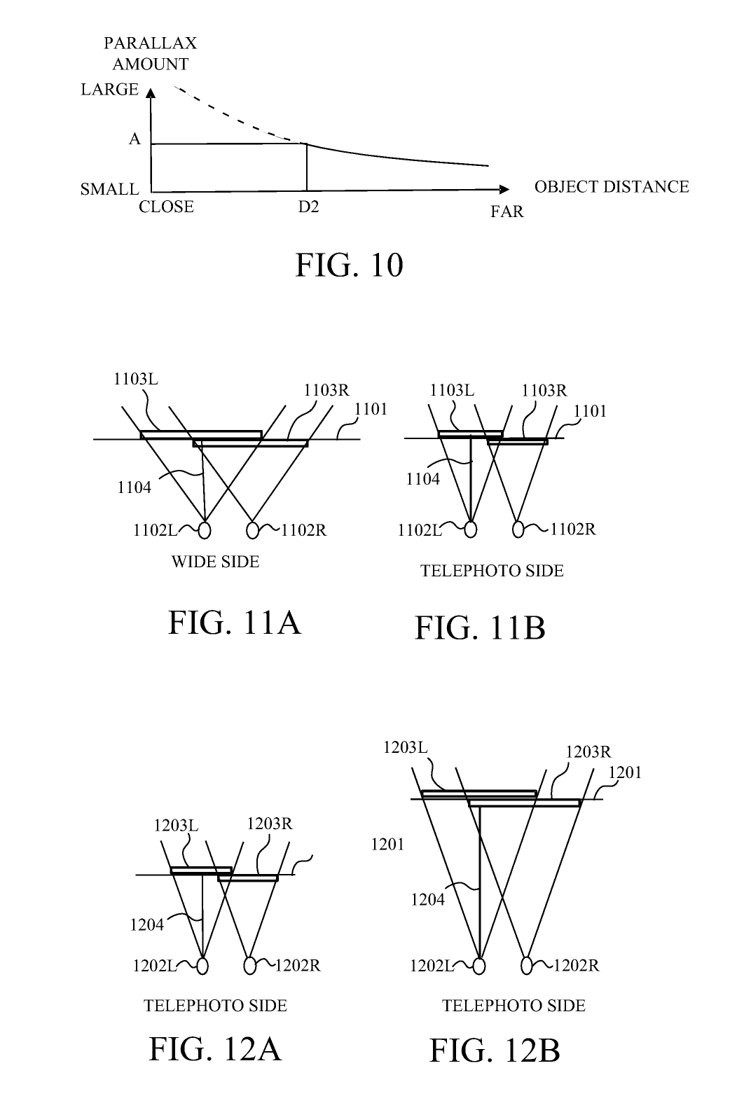

FIG. 10 is a schematic diagram illustrating a relation of the object distance and parallax when the focal length is the telephoto side. The horizontal axis and the longitudinal axis indicate the object distance and the parallax amounts, respectively. The parallax amount “A” at the object distance D2 is a limit value viewable stereoscopically. When the parallax amount is larger than the parallax amount “A”, the parallax amounts of the left and right grow larger and the stereoscopic effect is damaged. When the object distance is closer than D2, the parallax amounts is viewable stereoscopically. When the object distance is far than D2, stereoscopic image is photographable so that the parallax amounts and the angle of view are constantly maintained by using both the optical zoom and the digital zoom.

Therefore, when the object moves in a stereoscopic image pickup apparatus does not have the angle adjustment function, the stereoscopic photographing is possible without damaging the stereoscopic effect by using both the optical zoom and the digital zoom so as to maintain the angle of view according to the distance to the object.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-020246, filed on Feb. 5, 2013, which is hereby incorporated by reference herein in its entirety.

1. A stereoscopic image pickup apparatus comprising:
a plurality of image pickup units configured to acquire a plurality of images at each viewpoint by photographing an object from a plurality of different viewpoints;
a measuring unit configured to measure an object distance which is a distance between the plurality of image pickup units and the object;
a calculation unit configured to calculate an effective range where the plurality of images becomes parallax viewable stereoscopically;
a control unit configured to control a focal length of the plurality of the image pickup units so that the object distance and the focal length are within the effective range; and
an image expanding and reduction unit configured to expand each image region of the plurality of images according to a control of the focal length by the control unit.

2. The stereoscopic image pickup apparatus according to claim 1, further comprising an optical zoom variable range restriction unit configured to set a restriction value of an optical zoom variable range by using the effective range,
wherein the effective range is an optical zoom effective range calculated according to the object distance by the calculation unit, and
wherein the control unit changes the focal length to the restriction value if the focal length is larger than the restriction value.

3. The stereoscopic image pickup apparatus according to claim 2,
wherein the focal length before being controlled by the control unit is outside the optical zoom effective range and is a telephoto side than the restriction value, and
wherein the image expanding and constructing unit performs a digital zoom relative to the image region.

4. The stereoscopic image pickup apparatus according to claim 3, wherein the image expanding and constructing unit performs a digital zoom so as to cancel a change of an angle of view by a control of the focal length.

5. The stereoscopic image pickup apparatus according to claim 4, wherein the image expanding and constructing unit performs a digital zoom so that parallax after a control of the focal length by the control unit approaches parallax before a control of the focal length.

6. The stereoscopic image pickup apparatus according to 1, further comprising a distance determining unit configured to compare the effective range with the object distance,
wherein the effective range is an object distance effective range calculated according to the focal length by the calculation unit, and
wherein if the object distance is outside the object distance effective range, the control unit controls the focal length so that the object distance is within the object distance effective range and the image expanding and constructing unit performs a digital zoom relative to the image region.

7. The stereoscopic image pickup apparatus according to claim 6, wherein the control unit control the focal length to a wide side if the object distance is outside the object distance effective range by approaching the object to the plurality of the image pickup units.

8. The stereoscopic image pickup apparatus according to claim 6, wherein the image expanding and constructing unit performs a digital zoom so as to cancel a change of an angle of view by a control of the focal length.

9. The stereoscopic image pickup apparatus according to claim 8, wherein the image expanding and constructing unit performs a digital zoom so that parallax after a control of the focal length by the control unit approaches parallax before a control of the focal length.
